(19) United States
(12) Patent Application Publication
(10) Pub. No.: US 2016/0377740 A1
(43) Pub. Date: Dec. 29, 2016

(54) APPARATUS AND METHOD FOR READING OUT STORAGE PHOSPHOR PLATES

(71) Applicant: AGFA HEALTHCARE N.V., Mortsel (BE)

(72) Inventor: Heribert HAMMER, Mortsel (BE)

(73) Assignee: AGFA HEALTHCARE N.V., Mortsel (BE)

(21) Appl. No.: 15/039,446

(22) PCT Filed: Nov. 12, 2014
(86) PCT No.: PCT/EP2014/074392

§ 371 Date: May 26, 2016

(30) Foreign Application Priority Data
Nov. 27, 2013 (EP) 13194600.6

(51) Int. Cl. G01T 1/20; G03B 42/04; G03B 42/08

(52) U.S. Cl. CPC G01T 1/2014; G03B 42/08; G03B 42/045

(57) ABSTRACT

An apparatus for reading out x-ray information stored in a storage phosphor plate includes an input device having a slot through which a cassette is inserted into the input device, the cassette configured to accommodate a storage phosphor plate, therein, and a read-out device that irradiates the storage phosphor plate with stimulation light and detecting emission light stimulated by the phosphor plate. The input device receives cassettes having different cassette widths, and the input device includes one or more first elements that align and/or fix the cassettes having different cassette widths in the input device, and/or one or more second elements that close the slot of the input device in order to prevent ambient light from passing through the slot when cassettes having different cassette widths are inserted into the input device.

### CROSS-REFERENCE TO RELATED APPLICATIONS

This application is a 371 National Stage Application of PCT/EP2014/074392, filed Nov. 12, 2014. This application claims the benefit of European Application No. 13194600.6, filed Nov. 27, 2013, which is incorporated by reference herein in its entirety.

### BACKGROUND OF THE INVENTION

1. Field of the Invention

The present invention relates to an apparatus and a method for reading out x-ray information stored in a storage phosphor plate.

2. Description of the Related Art

One possibility for recording X-ray images is to store X-ray radiation passing through an object, for example a patient, as a latent image in a so-called storage phosphor layer. In order to read out the latent image the storage phosphor layer is irradiated with stimulation light and thereby stimulated to emit emission light. The emission light, the intensity of which corresponds to the image stored in the storage phosphor layer, is detected by an optical detector and converted into electrical signals. Furthermore, the electrical signals are processed as required and finally made available for analysis, in particular for medical and/or diagnostic purposes, by being displayed on an appropriate display device, such as e.g. a monitor or printer.

EP 2 573 616 A1 shows an according read-out apparatus comprising an input device for receiving a cassette accommodating a storage phosphor plate. When the cassette is inserted into the input device, the cassette is fixed in the input device and/or opened by mechanically driven elements.

### SUMMARY OF THE INVENTION

It is an object of the present invention to provide an apparatus and an according method allowing for reading out storage phosphor plates accommodated in cassettes of at least two different formats.

These objects are achieved by the method and the system defined below.

An apparatus for reading out x-ray information stored in a storage phosphor plate comprises an input device having a slot through which a cassette can be inserted into the input device, the cassette being designed for accommodating a storage phosphor plate, and a read-out device for irradiating the storage phosphor plate with stimulation light and detecting emission light stimulated in the phosphor plate. According to a preferred aspect of the invention, the input device is designed for receiving cassettes having different cassette widths, wherein the input device comprises one or more first elements designed for aligning and/or fixing cassettes having different cassette widths in the input device and/or one or more second elements designed for shutting the slot of the input device in order to prevent ambient light from passing through the slot when cassettes having different cassette widths are inserted into the input device.

A method for reading out x-ray information stored in a storage phosphor plate comprises the steps of inserting a cassette into an input device through a slot of the input device, the cassette being designed for accommodating a storage phosphor plate, and reading out the storage phosphor plate by irradiating the storage phosphor plate with stimulation light and detecting emission light stimulated in the phosphor plate. According to a preferred aspect of the invention, the method further comprises the steps of aligning and/or fixing cassettes, which have different cassette widths, in the input device by one or more first elements and/or shutting the slot of the input device by one or more second elements in order to prevent ambient light from passing through the slot when cassettes having different cassette widths are inserted into the input device.

Preferably, the term “cassette width” relates to the dimension of a cassette along a direction which is essentially parallel to the extension of an opening of the cassette through which the storage phosphor plate can be removed from the cassette. Additionally or alternatively, the term “cassette width” may relate to the dimension of a cassette along a direction which is essentially perpendicular to the direction in which the cassette is inserted into the input unit. Additionally or alternatively, the term “cassette width” may relate to the dimension of a cassette along a direction which is essentially parallel to the extension of the slot of the input device.

Preferred embodiments of the invention are based on the approach to provide an input device into which cassettes having different cassette widths can be inserted. First elements for aligning and/or fixing a cassette in the input unit and/or second elements for shutting a section of the slot, which is not “covered” or “occupied” with the inserted cassette of a given cassette width, are preferably arranged such that for each cassette width of the cassettes, which can be inserted into the input device, specific or corresponding first and/or second elements are provided. For example, for aligning and/or fixing a cassette having a first cassette width first and/or second elements having a first position and/or first design are provided, whereas for aligning and/or fixing a cassette having a second cassette width, which is e.g. larger than the first cassette width, first and/or second elements having a second position and/or second design are provided. Same applies accordingly for first and/or second elements provided for cassettes having a third, fourth, fifth etc. cassette width. According to a particularly preferred aspect of the invention, the first and/or second elements comprise mechanical elements, which are driven by a pure mechanical drive, i.e. driven, e.g., without electromechanical devices like motors.

In summary, preferred embodiments of the invention allow for reading out storage phosphor plates accommodated in cassettes of at least two different formats.

Preferably, the first elements comprise at least one aligning element for each of the at least two different cassette widths, wherein each of the at least one aligning elements is designed for aligning and/or fixing a cassette of a given cassette width in the input device. For example, each of the aligning elements is designed for being pressed against a side face of the cassette, whereby the cassette is advanced by the aligning element along a direction parallel to the extension of the slot and/or pressed against an end stop provided at the opposite side face of the cassette.

In particular, the first elements further comprise at least one end stop, in particular a side end stop, and each of the at least one aligning elements being positioned such that when a cassette of a first cassette width is inserted, the cassette is pressed against the end stop by a first aligning element having a first position, and when a cassette of a second cassette width is inserted, the cassette is pressed against the end stop by a second aligning element having a second position, which is different from the first position. In particular, the distance between the first and the second position of the first and second aligning element approximately corresponds to the difference between the first and the second cassette width.

It is particularly preferred that the first and second aligning elements are provided at different positions along a first direction running parallel to the extension of the slot of the input device and/or parallel to the extension of the opening of a cassette inserted into the slot.

It is, moreover, preferred that the first and second aligning elements are mounted on a first mounting element, e.g. a rod-like element. Preferably, the first and/or second aligning elements are pivotably mounted on the first mounting element.

In another preferred embodiment the apparatus further comprises a first guiding element arranged and/or formed for interacting with the first mounting element, whereby the first mounting element can be shifted parallel to the first direction. Preferably, the first guiding element is, preferably rigidly, mounted on a base of the input device.

In yet another preferred embodiment the apparatus further comprises a carrier designed for being displaced, preferably relative to the base of the input device, in a second direction, which is perpendicular to the first direction, by a cassette being inserted into the input device. The first mounting element is provided, preferably mounted, on the carrier such that when the carrier is displaced in the second direction the first mounting element moves relative to the first guiding element and is therefore interacting with the latter. Preferably, the first guiding element is wedge-shaped such that when the first mounting element, in particular a mounting rod, is moved in the second direction relative to the wedge-shaped guiding element, the former is shifted or advanced parallel to the first direction.

According to a further preferred embodiment of the invention, the second elements comprise at least one cover element for each of the at least two different cassette widths, wherein each of the at least one cover element is designed for shutting the slot of the input device when a cassette of a given cassette width is inserted in the input device.

In particular, each of the at least one cover elements being positioned such that when a cassette of a first cassette width is inserted, the slot is shut by a first cover element having a first position and a second cover element having a second position, which is different from the first position, and when a cassette of a second cassette width is inserted, the slot is shut by the second cover element.

In yet another preferred embodiment the first and second cover elements are provided at different positions along a first direction parallel to the extension of the slot of the input device and/or to the extension of the opening of a cassette inserted into the slot.

It is further preferred that the first and second cover elements are mounted on a second mounting element. Preferably, the first and/or second cover elements being pivotably mounted on the second mounting element. For example, the second mounting element may be a rod-like mounting element.

Preferably, a carrier is provided which is designed for being displaced in a second direction, which is perpendicular to the first direction, by a cassette being inserted into the input device.

It is, moreover, preferred that the apparatus further comprises a second guiding element arranged and/or formed for interacting with the second mounting element, such that the second mounting element is shifted parallel to the first direction, whereby the first and/or second cover element is/are pressed against the inserted cassette. In particular, the second guiding element is, in particular rigidly, mounted on the carrier and/or rigidly coupled with the carrier.

It is, moreover, preferred that the second mounting element is provided on the carrier such that when the carrier is displaced in the second direction the second mounting element is interacting with the second guiding element so that the second mounting element is shifted or advanced parallel to the first direction, whereby the first and/or second cover element is/are moved towards and/or pressed against the inserted cassette.

### BRIEF DESCRIPTION OF THE DRAWINGS

Further advantages, aspects and examples of the present invention will be apparent from the description of following figures:

FIG. 1 shows an example of a read-out device for reading out a storage phosphor plate.

FIG. 2 shows a cross section of an example of an apparatus for reading out storage phosphor plates.

FIG. 3 shows a perspective view of an example of an input device.

FIG. 4 shows a perspective view of the input device in a first state together with an inserted cassette of a first format.

FIG. 5 shows a perspective view of the input device in a second state together with the inserted cassette of the first format.

FIG. 6 shows a perspective view of the input device in a first state together with an inserted cassette of a second format.

FIG. 7 shows a perspective view of the input device in a second state together with the inserted cassette of the second format.

### DETAILED DESCRIPTION OF THE PREFERRED EMBODIMENTS

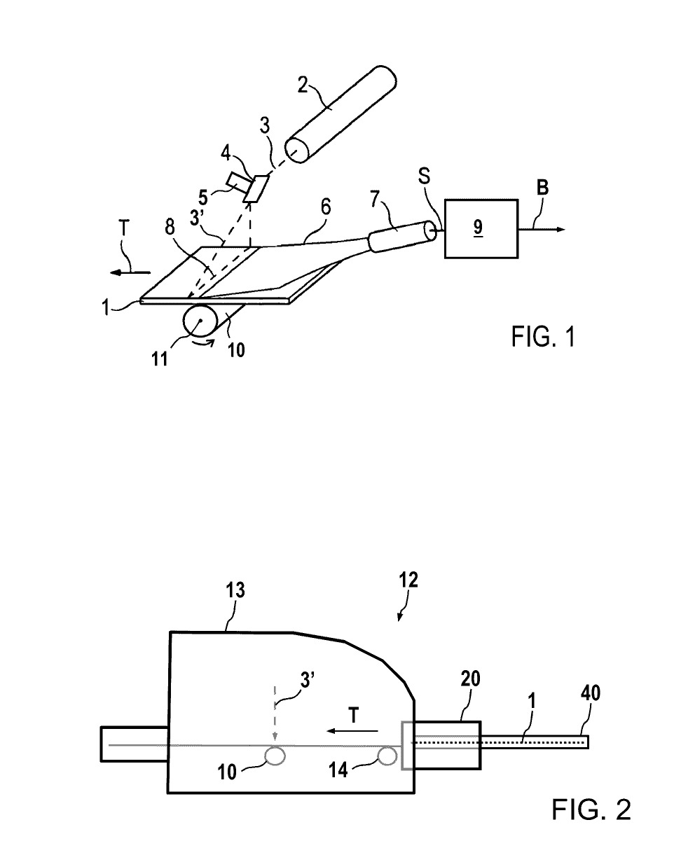

FIG. 1 shows a read-out device for reading out a storage phosphor plate 1. By a laser 2 a stimulation light beam 3 is generated, which is deflected by a deflector 4 such that the deflected beam 3′ moves along a line 8 over the storage phosphor plate 1. The deflector 4 has a reflective surface, in particular in the form of a mirror, which is caused to oscillate by a driving device 5. Alternatively, the deflector 4 may be a polygon mirror which is rotated by the driving device 5, e.g. a motor.

During the movement of the deflected stimulation light beam 3′ over the storage phosphor plate 1 the latter emits, as a function of x-ray information stored therein, emission light which is collected by an optical collector 6, for example a light guide and/or a fiber bundle, detected by an optical detector 7, preferably a photomultiplier tube (PMT) and thereby converted into a corresponding detector signal S which is supplied to a processing device 9, in which digital image signal values B for individual pixels of the read-out x-ray image are derived.

Due to conveying the storage phosphor plate 1 in a transport direction T by a transport device, individual lines 8 of the storage phosphor plate 1 are successively read out and thus a two-dimensional x-ray image made up of individual pixels with associated image signal values B is obtained. The transport device preferably comprises a roller 10 which is rotated about a rotational axis 11 by a respective roller drive (not shown) and conveys the storage phosphor plate 1, preferably due to frictional and/or magnetic forces between the storage phosphor plate 1 and the roller 10.

FIG. 2 shows a cross section of an apparatus 12 for reading out storage phosphor plates. The apparatus 12 comprises a housing 13 in which a read-out device, like the one exemplarily shown in FIG. 1, is provided.

An input device 20 is provided in a front portion of the housing 13 of the apparatus 12, into which a cassette 40 accommodating a phosphor plate 1 can be inserted by an operator. In the given example, the insertion of the cassette 40 occurs in a substantially horizontal direction. Alternatively, it is also possible to provide the input device 20 at a different location of the housing 13, for example at the top or in a transition region between the top and the front portion of the housing 13. In such cases, the cassette 40 is inserted into the input device 20 along a vertical or inclined direction, respectively.

In the vicinity of the input device 20 inside the housing 13 a removal device 14 is provided, which is designed for taking the storage phosphor plate 1 out of the cassette 40 and forwarding same along transport direction T to the roller 10 of the read-out device. Further, the removal device 14 is designed for feeding the storage phosphor plate 1 into the cassette 40 after it has been read out.

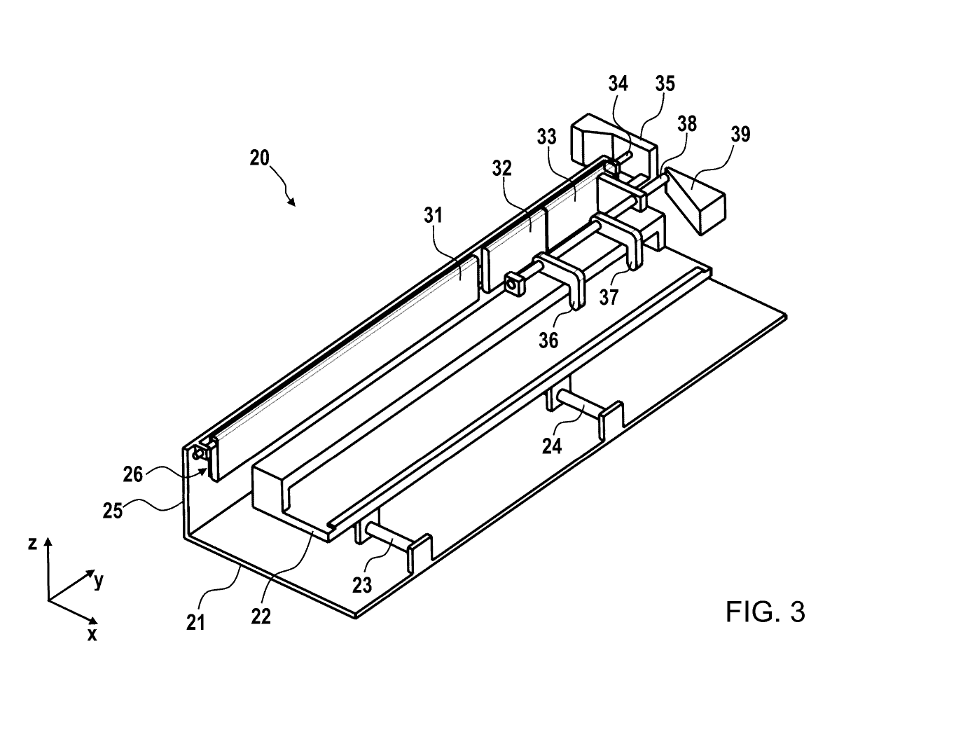

FIG. 3 shows a perspective view of an example of an input device 20 comprising a base 21 and a carrier 22 which is movably mounted on the base 21, preferably by guide rails 23 and 24, such that the carrier 22 can be moved along the x-direction. Preferably, the carrier 22 is biased, for example by coil springs or leaf springs, such that it is automatically reset into an initial position near a front part 25 of the input device 20.

In the front part 25 a slot 26 extending along the y-direction is provided. The slot 26 is arranged and/or formed such that a cassette (not shown) can be inserted through the slot 26 and positioned on the carrier 22 located behind and near the slot 26.

In the case shown in FIG. 3, where no cassette has been inserted into the input device 20, the slot 26 is preferably covered by cover elements 31 to 33 which are pivotably mounted on a common mounting element 34, for example a mounting rod. The mounting element 34 interacts with a guiding element 35 which is preferably coupled with the carrier 22 such that moving the carrier 22 in the x-direction results in an according movement of the guiding element 35 relative to the mounting element 34. Preferably, the mounting element 34 is biased, e.g. by a coil spring, against the guiding element 35.

Moreover, aligning elements 36 and 37 are provided which are pivotably mounted on a common mounting element 38, preferably a mounting rod, which interacts with a guiding element 39. In distinction to the guiding element 35, the guiding element 39 is preferably coupled with the base 21 such that when the carrier 22 is moved relative to the base 21 along the x-direction, the mounting element 38 moves relative to the guiding element 39.

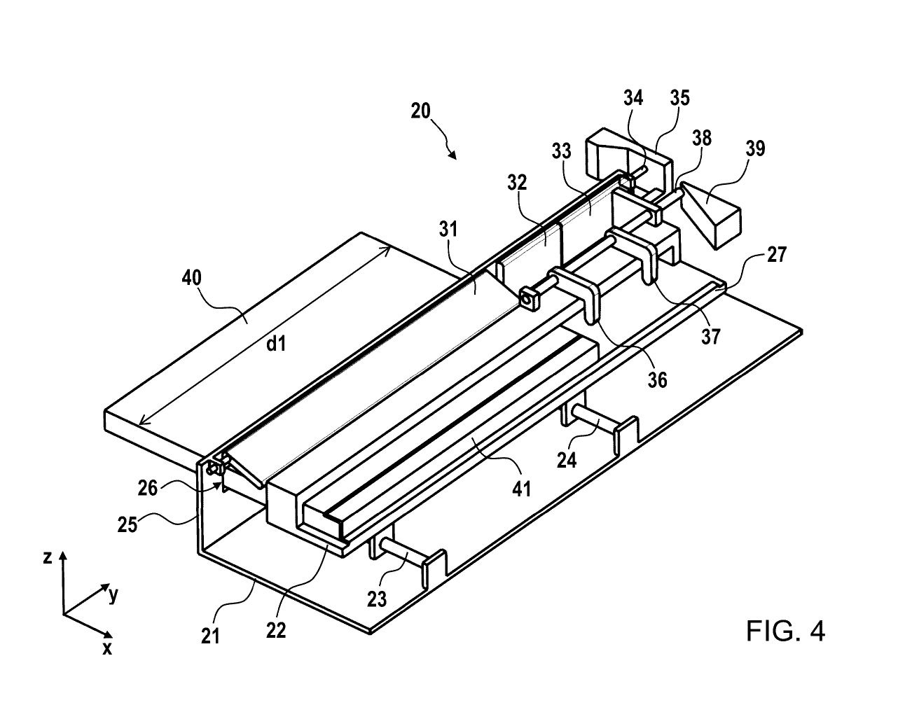

In the following, the functioning of the input device 20 will be explained in more detail with reference to FIGS. 4 to 7.

FIG. 4 shows a perspective view of the input device 20 in a first state together with an inserted cassette 40 of a first format. The cassette 40 has the form of a flat rectangular prism on which an opening is provided at one of the narrow front sides. In order to shut the opening, which preferably extends over the whole width of the respective narrow front side, a hinged cassette lid 41 is provided. The front side, at which the opening and the cassette lid 41 are provided, corresponds to the leading front side with which the cassette 40 is inserted into the input device 20 and is also referred to as “opening side”. The cassette 40 has a cassette width d1, preferably extending along the y-direction, and a cassette length, preferably extending along the x-direction. Typical cassette widths the input unit 20 is designed for are 24 cm, 30 cm and 35 cm.

In the shown first state of the input device 20, the cassette 40 has been inserted through slot 26 of front part 25 until the leading face of the cassette 40, on which the cassette lid 41 is provided, reaches carrier stop end 27 provided at the carrier 22. When passing the slot 26, a first cover element 31 is tilted upwards into a position shown in the figure, whereas second and third cover element 32 and 33 remain in a vertical position in which they cover the most part of the remaining slot 26 being adjacent to the cassette 40.

Regarding the remaining components of the input device 20, the above-mentioned remarks with reference to FIG. 3 apply accordingly.

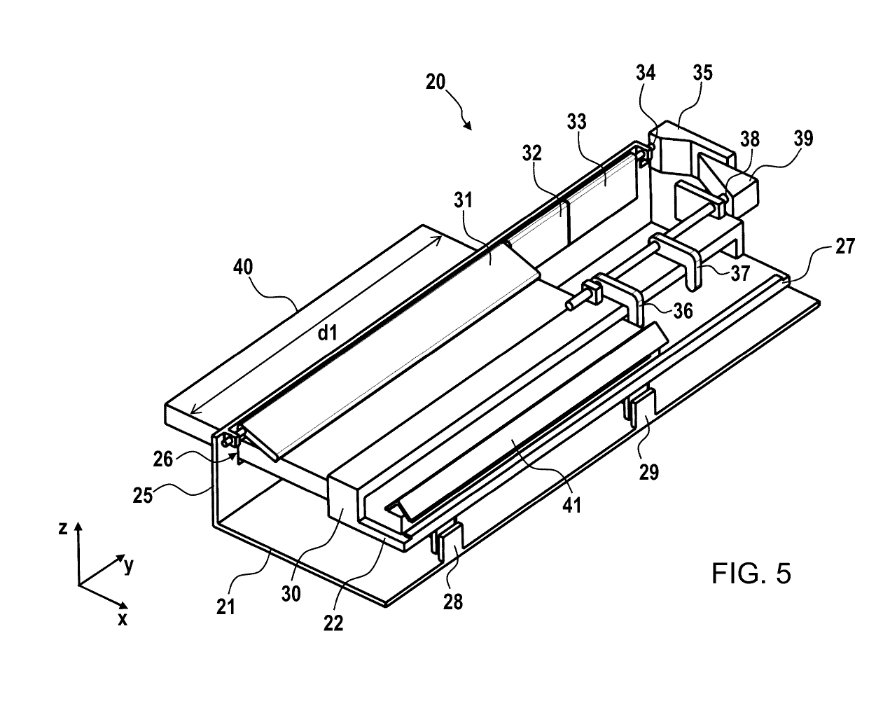

FIG. 5 shows a perspective view of the input device 20 in a second state together with the inserted cassette 40 of the first format. In distinction to the first state shown in FIG. 4, the cassette 40 has been pushed in x-direction, whereby the carrier 22 moved along with the cassette 40 until base end stops 28 and 29 provided at the base 21 are reached. Because guiding element 35 is, preferably rigidly, coupled with the moving carrier 22, the guiding element 35 is moved relative to the mounting rod 34 of cover elements 31 to 33. An elevated section of the guiding element 35 interacts with the mounting rod 34 such that the biased mounting rod 34 is urged along the y-direction so that the second and third cover elements 32 and 33 are moved towards the narrow side of the cassette 40 such that the remaining section of the slot 26, which is not covered by the cassette 40, is light-tightly shut by the cover elements 32 and 33.

Moreover, the biased mounting rod 38, which is preferably rigidly coupled with the carrier 22, has moved together with the movement of the carrier 22 in the x-direction and interacted with guiding element 39, which is preferably rigidly coupled with the base 21, whereupon the mounting rod 38 was advanced in parallel to the y-direction. By this structure, the first aligning element 36 mounted on the mounting rod 38 was pressed against the side face of cassette 40 such that the cassette 40 is advanced in parallel to the y-direction and/or pressed against a side end stop 30 which is provided on the carrier 22 at the opposite side face of the cassette 40. In this way, an alignment and/or fixing of the cassette 40 are effected. Preferably, in the shown second state the cassette lid 41 is opened by appropriate opening elements, like hook-shaped elements as shown in EP 2 573 618 A1.

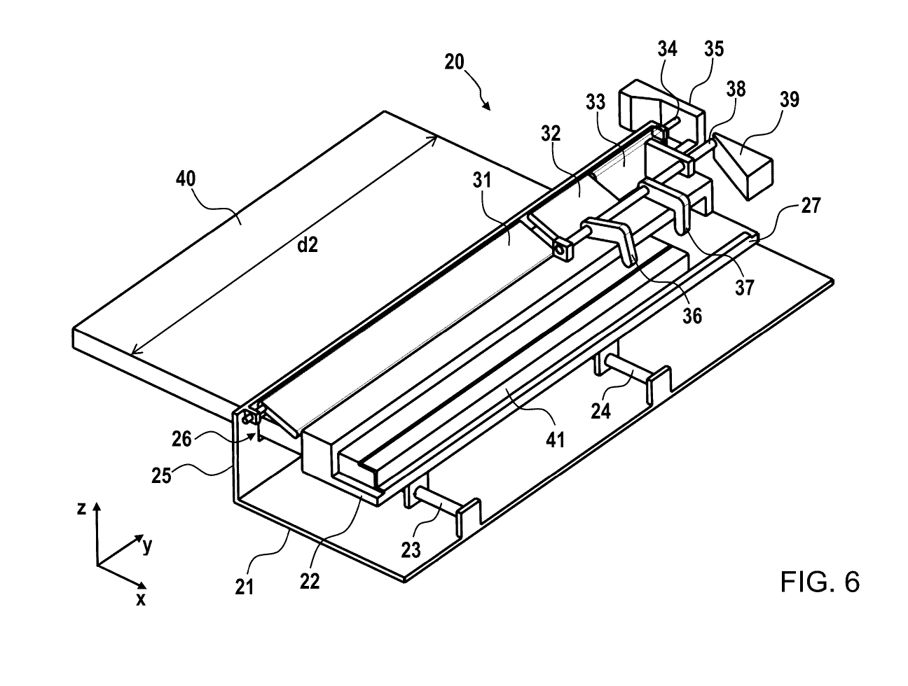

FIG. 6 shows a perspective view of the input device 20 in a first state together with an inserted cassette 40 of a second format. In this example, the dimension of the cassette 40 at the side end of the opening corresponds to a width d2 being larger than the width d1 of the cassette 40 shown in FIGS. 4 and 5.

As a result, by inserting the cassette 40 of the larger format into the input device 20 not only the first cover element 31 but also the second cover element 32 is tilted up, whereas the third cover element 33 remains in its vertical position. Moreover, the first aligning element 36 which is pivotably mounted on mounting rod 38 is tilted up when the leading face of the cassette comes into contact with the lower part of the hook-shaped first aligning element 36 while the cassette 40 is being moved in the x-direction until carrier stop end 27 is reached.

Regarding the functioning of the remaining components of the input device 20 shown in FIG. 6, the above-mentioned remarks with reference to the example shown in FIG. 4 apply accordingly.

Like with the example shown in FIG. 5, the cassette 40 of the second format has been, preferably manually, pushed into the input device 20 parallel to the x-direction, whereby the carrier 22 is moved along with the movement of the cassette 40 until base end stops 28 and 29 are reached.

During the movement of the carrier 22 in the x-direction, the guiding element 35 coupled with the carrier 22 is moved relative to the biased mounting rod 34, whereby the latter was pushed parallel to the y-direction, when interacting with the elevated portion of the guiding element 35. As a result, the third cover element provided on the mounting rod 34 is advanced towards the side face of the cassette 40 and is finally pressed against it such that the remaining portion of the slot 26 at the front part 25 is light-tightly shut by the third cover element 33.

Likewise, mounting rod 38 provided at the carrier 22 is moved along with the carrier 22 relative to wedge-shaped guiding element 39, whereby the biased mounting rod 38 together with the second aligning element 37 provided on the mounting rod 38 are advanced parallel to the y-direction towards the side face of the cassette 40. By this structure, the hook-shaped second guiding element 37 comes into contact with the side face of the cassette 40 and advances the cassette 40 against the side end stop 30 provided on the carrier 22, whereby the cassette 40 is aligned and/or fixed on the carrier 22.

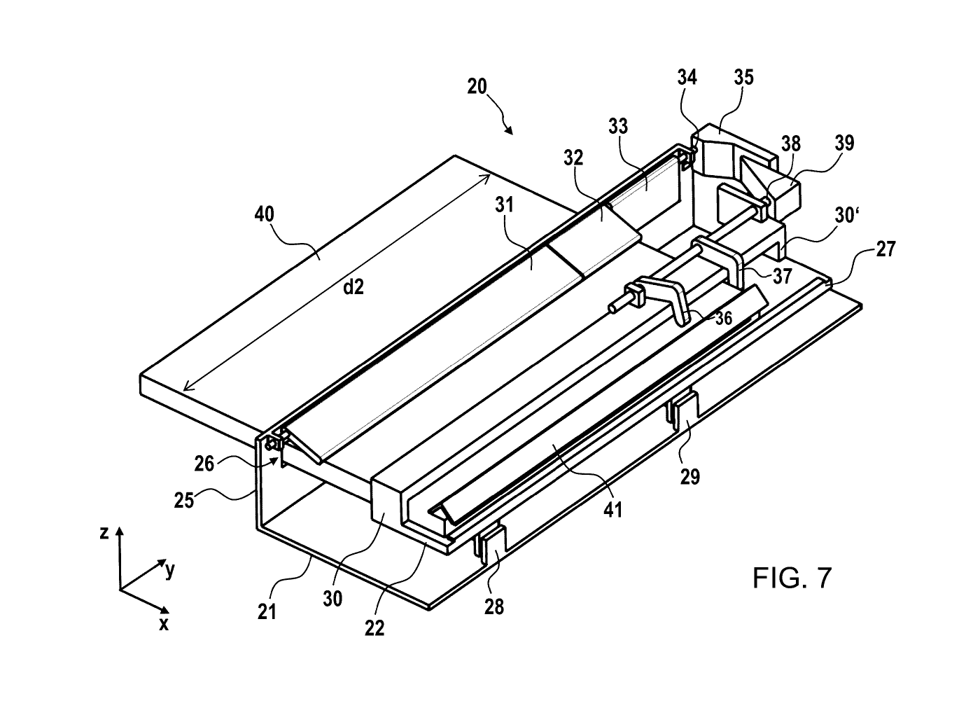

The input device 20 shown in FIGS. 3 to 7 is also designed for receiving cassettes 40 of a third format having a cassette width d3 being larger than the width d1 and d2 of the cassette 40 shown in FIGS. 4 and 5 or FIGS. 6 and 7, respectively. Preferably, the cassette width d3 of the cassette 40 of the third format corresponds to the width of the slot 26 such that the cassette 40, when inserted into the input device 20, covers in essential the whole slot 26. Additional light shutting can be omitted in this case. Accordingly, not only the first and second cover elements 31 and 32 are tilted up, but also the third cover element 33. Preferably, the cassette 40 of the third format may be aligned and/or fixed on the carrier 22 by means of a further side end stop 30′ (see FIG. 7), which is provided on the carrier 22 opposite to side end stop 30 and can be advanced parallel to the y-direction due to interaction with the wedge-shaped guiding element 39. Accordingly, the further side end stop 30′ acts as an aligning element, like the first and second aligning elements 36 and 37.

In summary, by providing cover elements 31 to 33 and/or aligning elements 36, 37 and 30′ at different positions along the y-direction and advancing these elements by guided mounting elements 34 or 38, respectively, an alignment and/or fixing of cassettes and/or a light-tight shutting of the input slot 26 can be achieved in a simple and reliable manner in cases when cassettes of three different formats are inserted into the input device 20. Moreover, the covering and/or aligning mechanisms described above are designed for being purely mechanically driven and therefore particularly robust and cheap in manufacturing.

Although the functioning of the input device 20 has been elucidated by cassettes 40 of three different cassette widths d1, d2 and d3, the approach set forth above can be applied to input devices 20 which are designed for cassettes 40 of more than three different cassette widths.

1-16. (canceled)

17. An apparatus for reading out x-ray information stored in a storage phosphor plate, the apparatus comprising:
an input device including a slot through which a cassette is inserted into the input device, the cassette configured to accommodate a storage phosphor plate therein; and
a read-out device that irradiates the storage phosphor plate with stimulation light and that detects emission light stimulated in the storage phosphor plate; wherein
the input device is structured to receive cassettes having different cassette widths and includes:
a plurality of first elements that align and/or fix the cassettes having different cassette widths in the input device; and/or
a plurality of second elements that close the slot of the input device in order to prevent ambient light from passing through the slot when the cassettes having different cassette widths are inserted into the input device.

18. The apparatus according to claim 17, wherein the plurality of first elements include an aligning element for each of the cassettes having different cassette widths, and each of the aligning elements aligns and/or fixes a first cassette having a first cassette width in the input device.

19. The apparatus according to claim 18, the plurality of first elements further includes at least one end stop, and each of the aligning elements is positioned such that:
when the first cassette having the first cassette width is inserted into the input device, the first cassette is pressed against the at least one end stop by a first aligning element located at a first position; and
when a second cassette having a second cassette width is inserted into the input device, the second cassette is pressed against the at least one end stop by a second aligning element located at a second position, which is different from the first position.

20. The apparatus according to claim 19, wherein the first aligning element and the second aligning element are located at different positions along a first direction parallel to the slot of the input device and/or to an opening of the cassette inserted into the slot.

21. The apparatus according to claim 20, wherein the first aligning element and the second aligning element are mounted on a first mounting element.

22. The apparatus according to claim 21, wherein the first aligning element and/or the second aligning element are pivotably mounted on the first mounting element.

23. The apparatus according to claim 21, further comprising a first guiding element that interacts with the first mounting element such that the first mounting element is shifted parallel to the first direction.

24. The apparatus according to claim 23, further comprising a carrier that is displaced in a second direction, which is perpendicular to the first direction, by the cassette being inserted into the input device; wherein
the first mounting element is provided on the carrier such that when the carrier is displaced in the second direction, the first mounting element interacts with the first guiding element so that the first mounting element is shifted parallel to the first direction.

25. The apparatus according to claim 17, wherein the plurality of second elements includes a cover element for each of the cassettes having different cassette widths, and each of the cover elements closes the slot of the input device when a cassette is inserted into the input device.

26. The apparatus according to claim 25, wherein each of the cover elements is positioned such that:
when a first cassette having a first cassette width is inserted into the input device, the slot is closed by a first cover element of the cover elements having a first position and a second cover element of the cover elements having a second position, which is different from the first position; and
when a second cassette having a second cassette width is inserted into the input device, the slot is closed by the second cover element.

27. The apparatus according to claim 26, wherein the first cover element and the second cover element are located at different positions along a first direction parallel to the slot of the input device and/or to an opening of the cassette inserted into the slot.

28. The apparatus according to claim 27, wherein the first cover element and the second cover element are mounted on a mounting element.

29. The apparatus according to claim 28, wherein the first cover element and/or the second cover element are pivotably mounted on the mounting element.

30. The apparatus according to claim 28, further comprising a guiding element that interacts with the mounting element such that the mounting element is shifted parallel to the first direction, wherein the first cover element and/or the second cover element is/are pressed against the cassette.

31. The apparatus according to claim 30, further comprising a carrier that is displaced in a second direction, which is perpendicular to the first direction, by the cassette being inserted into the input device; wherein
the second mounting element is provided on the carrier such that when the carrier is displaced in the second direction, the mounting element interacts with the guiding element so that the mounting element is shifted parallel to the first direction, and the first cover element and/or the second cover element is/are shifted towards and/or pressed against the cassette.

32. A method for reading out x-ray information stored in a storage phosphor plate, the method comprising the steps of:
inserting a cassette into an input device through a slot of the input device, the cassette accommodating a storage phosphor plate therein;
reading the storage phosphor plate by irradiating the storage phosphor plate with stimulation light and detecting emission light stimulated in the storage phosphor plate;
aligning and/or fixing cassettes having different cassette widths in the input device using one or more first elements; and/or
closing the slot of the input device using one or more second elements in order to prevent ambient light from passing through the slot when the cassettes having the different cassette widths are inserted into the input device.
